(19) United States
(12) Patent Application Publication
(10) Pub. No.: US 2006/0138371 A1
(43) Pub. Date: Jun. 29, 2006

(54) Electrically-driven valve comprising a microporous membrane

(76) Inventor: Francis Garnier, Champigny Sur Marne (FR)

Correspondence Address: OLIFF & BERRIDGE, PLC, P.O. BOX 19928, ALEXANDRIA, VA, 22320, US

(21) Appl. No.: 10/562,445

(22) PCT Filed: Jul. 8, 2004
(86) PCT No.: PCT/FR04/50316

§ 371 Date: Dec. 27, 2005

(30) Foreign Application Priority Data
Jul. 10, 2003 (FR) 0308443

(51) Int. Cl. F16K 31/02

(52) U.S. Cl. 251/129.01

(57) ABSTRACT

The present invention essentially relates to an electrically-controlled valve formed by electroactive polymers and more precisely an electrically controlled fluidic valve separating two volume spaces, which includes: at least one microporous membrane, the surface of which is at least partly covered with at least one electroactive polymer essentially placed within the pores of said microporous membrane, so that, when said polymer is in a defined oxidation-reduction state, it blocks off said pores; and an electrical supply intended to allow said valve to switch from the closed state to the open state, and vice versa, by changing the oxidation-reduction state of the electroactive polymer. The invention also relates to a microfluidic device including such a valve.

The present invention relates in general to the field of microfluidics. More precisely, the subject of the present invention is an electrically controlled valve formed by electroactive polymers.

The development of microfluidics, especially in the biomedical field, by means of microfluidic devices of the analysis card type, or else in the field of chemical synthesis using microreactors, has created a need for high-performance microvalves that are reliable and, most particularly, reusable.

In the biomedical field, various types of microvalve have been described. A first type relates to microvalves using a pyrotechnic effect. Such a valve has been described for example in document WO-A-98/22719. This is a miniature valve for filling the reservoir of a transdermal administration device. The principle of operation of this valve is based on the fragmentation of a substrate brought about by the combustion gases of a pyrotechnic charge, said substrate initially separating a reserve of fluid from an empty reservoir. This microvalve may, according to another embodiment, be used with an inflatable envelope. The combustion gases firstly rupture the substrate and then inflate the envelope for the purpose of pushing on a fluid so as to expel it.

These microvalves have as main drawback of not being reusable. In addition, their operation results in the emission of substrate fragments into the microcircuit.

Document WO-A-02/065005 discloses a multilayer microfluidic device using a bimetallic strip and an elastomer material of the PDMS (polydimethylsiloxane) type in which a channel is open. When a voltage is applied to the bimetallic strip, it deforms and flattens the flexible walls of the channel, thus occluding it.

Although this valve is reusable, it has a major drawback that lies in its constructional complexity (large number of layers) and the need to have a not insignificant temperature rise in the bimetallic strip in order to close the channel. Moreover, the level of sealability over time must also be quite low.

It also turns out that PDMS is not a material very suitable for the flow of a liquid in Microsystems for biological applications. This is because its highly hydrophobic character leads to the possibility of bubbles forming in the microfluidic circuit. It is difficult to process (cast) and it has a high adsorptivity for proteins.

Document U.S. Pat. No. 6,382,254 discloses a microfluidic valve for controlling the flow of a liquid through a channel. The operation of the valve is based on the use of a liquid (of the polyethylene oxide type) whose viscosity greatly increases with temperature (the liquid passes into the gel state).

This device has the drawback of having to mix the transported liquid with the activator liquid (compatibility problem, difficult processing) and of having to integrate a liquid into a confined space in the microfluidic device (if the activator liquid is not mixed with the transported liquid) and therefore filling problems that result therefrom. This device also has the major drawback of having to heat the liquid and/or the device up to 50° C., which is not very compatible with biological reactions at controlled temperatures and possibly with reactants cannot withstand such temperature rises, especially enzymes.

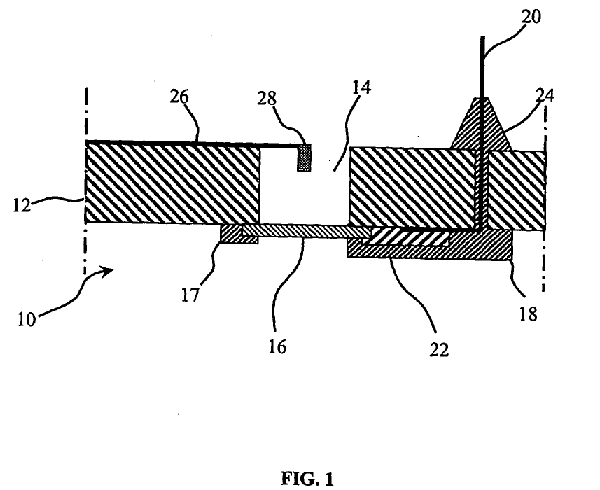

Other types of valves have also been described. These are valves formed by a film. This type of valve is mainly placed on the faces of analysis cards. These films may be self-adhesive and have nonadhesive regions at the valves. This for example is the case for patent application WO-A-00/13795 filed by the Applicant, which describes an invention on a device or analysis card for carrying out a reaction, or at least two reactions in parallel or in series, within it. The device is formed, on the one hand, by a network of channels within which it is possible to transfer at least one specimen to be treated and/or analyzed and, on the other hand, by at least one valve incorporated into the device for orienting each specimen transferred into the network and therefore for controlling the transfers, reactions and analyses carried out in said device. In the embodiment shown in FIGS. 1 to 3, it should be noted that a disc of elastomer is inserted between the self-adhesive film and the body of the card, thereby permitting the valve to be reused.

However, to produce a functional analysis card, such a structure increases the number of components and the costs.

The Applicant has also filed a patent application WO-A-00/78453. This relates to a valve, through which at least one channel passes, for directing at least one fluid driven by transfer means within an analysis card, the card having two faces joined together by an edge, characterized in that the valve is formed, on the one hand, by a film that is flexible and/or can be deformed, partly fastened to at least one of the faces of said card, and, on the other hand by a means for compressing the film, which means may be activated or deactivated. The fastening is performed on at least one of the plane faces by means of a fastener located in a depression peripheral to the valve, such as a groove.

The fastening is also provided by a weld peripheral to the valve in the bottom of the groove.

However, the flexible films used in this prior art are inert, that is to say they have only properties of undergoing structural deformation upon application of physical stresses. The succession of these stresses and their intensity may result in a permanent deformation, which may lead either to the valve being permanently closed or permanently open. Moreover, these deformation-induced opening and/or closing operations require the use of a mechanism for actuating the movement of the flexible films, this being bulky, cumbersome and likely to represent a not insignificant cost.

Non-inert polymers used for producing a valve have also been disclosed. Patent application WO-A-02/44566, in the name of the Applicant, discloses for example valves activated by electroactive polymers or by shape-memory materials. Such polymers can be used to produce valves, or more precisely minivalves, which are normally open or closed and which become respectively closed or open when an electrical current is applied to them. These valves consist, on the one hand of a film, which is flexible and/or may be deformed and fastened to the face of an analysis card and, on the other hand, of an actuator for the film, which allows said valve to be activated or deactivated, this actuator being formed by an electrical supply.

Although the valves described in the present patent application are particularly effective for producing surface valves, that is to say valves that are located on at least one of the faces of an analysis card, and therefore are in the form of a film, they can in no way be used within a channel or a duct, insofar as the deformation of a film does not constitute a suitable technical solution.

In addition, the use of electroactive polymers in large quantity for producing films represents an unacceptable financial cost when used to produce analysis cards, which must offer the lowest possible manufacturing costs so that they can be used on a wide scale.

With regard to this prior art, one essential object of the present invention is to propose a valve, more particularly a microvalve, that can be used in a microfluidic device of the analysis card type, both on the surface of the card and within a channel formed inside it.

Another essential object of the present invention is to propose a valve that can be used a large number of times.

Another object of the present invention is to propose a high-performance and reliable valve.

Another object of the present invention is to propose a valve which, while still being based on the use of electroactive polymers, has a lower manufacturing cost.

These objects, among others, are achieved by the present invention, which relates to an electrically controlled fluidic valve separating two volume spaces, which comprises:
at least one microporous membrane, the surface of which is at least partly covered with at least one electroactive polymer essentially placed within the pores of said microporous membrane, so that, when said polymer is in a defined oxidation-reduction state, it blocks off said pores; and
an electrical supply intended to allow said valve to switch from the closed state to the open state, and vice versa, by changing the oxidation-reduction state of the electroactive polymer.

The term “surface” is understood to mean the developed surface of the membrane.

The expression “defined oxidation-reduction state” is understood to mean that the polymer, when it closes off the pores, is either in the oxidized state or in the reduced state, depending on the type of polymer used.

Noteworthily, the microporous membrane according to the invention has approximately circular pores of approximately constant diameter.

Preferably, the electrical supply has at least one electrode and at least one counterelectrode. In addition, the electrode is formed by the microporous membrane.

In a first embodiment of the valve according to the invention, the microporous membrane is made of a nonconductive material.

Preferably, the nonconductive material is a polymer taken from the group comprising: polycarbonates (PC), polyamides (PA), polyethylene terephthalate (PET), polytetrafluoroethylene (PTFE) or Teflon®, and derivatives thereof.

For example, a polyamide may be nylon-6,6 polyamide.

A variant of this first embodiment consists in a nonconductive material which is a polymer taken from the group comprising: cellulose esters, cellulose nitrates and blends thereof.

Advantageously, this membrane further includes at least one external metal layer.

Even more advantageously, the membrane further includes at least one intermediate polymeric layer to which the external metal layer is fastened.

In a second embodiment of the valve according to the invention, the microporous membrane is made of a conductive material.

Preferably, the conductive material is a metal taken from the group comprising: gold, platinum, palladium or any other equivalent material well known to those skilled in the art.

According to another noteworthy feature of the invention the electroactive polymer is a conjugated polymer taken from the group comprising: polyaniline, polypyrrole, polythiophene, polyparaphenylvinylene, poly(p-pyridylvinylene) and derivatives thereof.

According to another noteworthy feature of the invention, the pore diameter lies in the range from 0.1 to 5 microns (μm), preferably from 0.2 to 1 μm.

According to another noteworthy feature of the invention, the microporous membrane has a thickness lying within the range from 10 μm to 1 mm, preferably from 10 to 30 μm.

Another subject of the invention is a microfluidic device, that includes at least one valve according to the invention.

Preferably, this microfluidic device is a microfluidic device of the analysis card type.

Another subject of the present invention is a process for producing a valve according to the invention. This process advantageously comprises the following steps:
a) a microporous membrane is placed in an electrolytic solution containing at least one monomer;
b) an electrochemical current is induced in said electrolytic solution;
c) the monomer is fixed on to the microporous membrane, and especially in the pores of said membrane;
d) the radial polymerization of the monomer in the pores of said membrane is carried out; and
e) the polymerization is stopped by cutting off the electrochemical current when the polymers reach the center of the pores, so that said polymers block the pores without overlapping one another.

According to a variant applicable when said membrane is made of a nonconductive material, the process includes a prior step of metalizing the microporous membrane, said metalization step comprising the following substeps:
a′) a microporous membrane is placed in a monomer solution;
b′) the monomer is fixed onto the microporous membrane;
c′) the polymerization of the monomer is carried out over the entire surface of the membrane so as to obtain a polymer layer;
d′) the membrane thus obtained is placed in a solution containing at least one metal salt; and
e′) the electrodeposition of the metal on the polymer layer is carried out by an oxidation-reduction reaction so that the microporous membrane is covered with a metal film.

According to one noteworthy feature, the monomer used in step a′) is taken from the group comprising: pyrrole, thiophene and derivatives thereof.

According to another noteworthy feature, the metal salt used in step d′) is taken from the group comprising: gold cyanide, gold chloride or any equivalent compound.

The present invention and the advantages that it affords will be more clearly understood in the light of the detailed description that follows, given with reference to the drawings in which:

FIG. 1 shows a cross-sectional view of a device for producing a valve according to the invention;

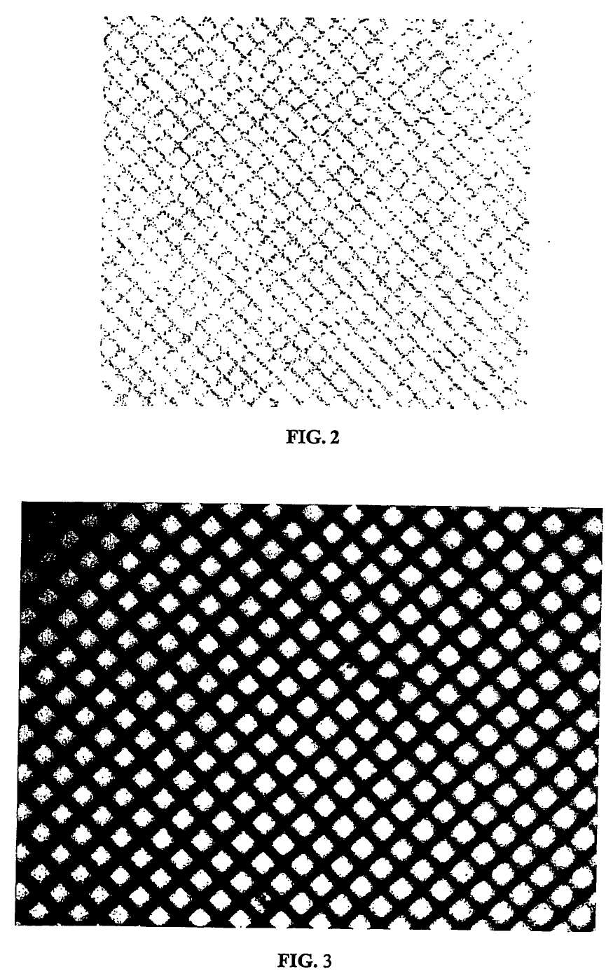

FIG. 2 shows a photograph of the top of the microporous membrane of the valve according to the invention, before polymerization;

FIG. 3 shows a photograph of the top of the microporous membrane of the valve according to the invention, during polymerization at an early stage in which the monomer covers the surface of the membrane;

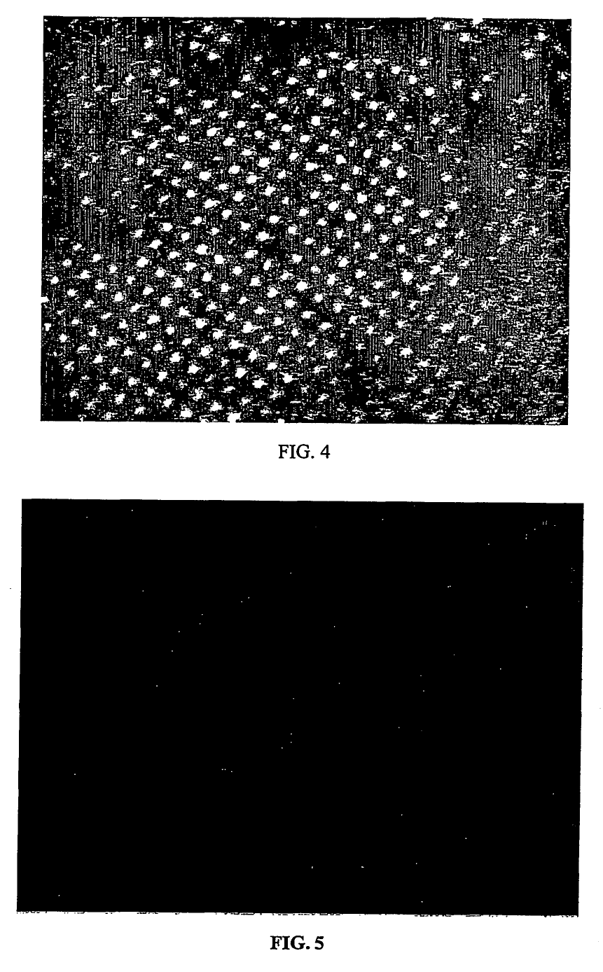

FIG. 4 shows a photograph of the top of the microporous membrane of the valve according to the invention, during polymerization at an advanced stage in which the polymer partly blocks the pores of the membrane;

FIG. 5 shows a photograph of the top of the microporous membrane of the valve according to the invention, after polymerization when the polymer completely blocks the pores of the membrane, that is to say when the valve is in the closed state;

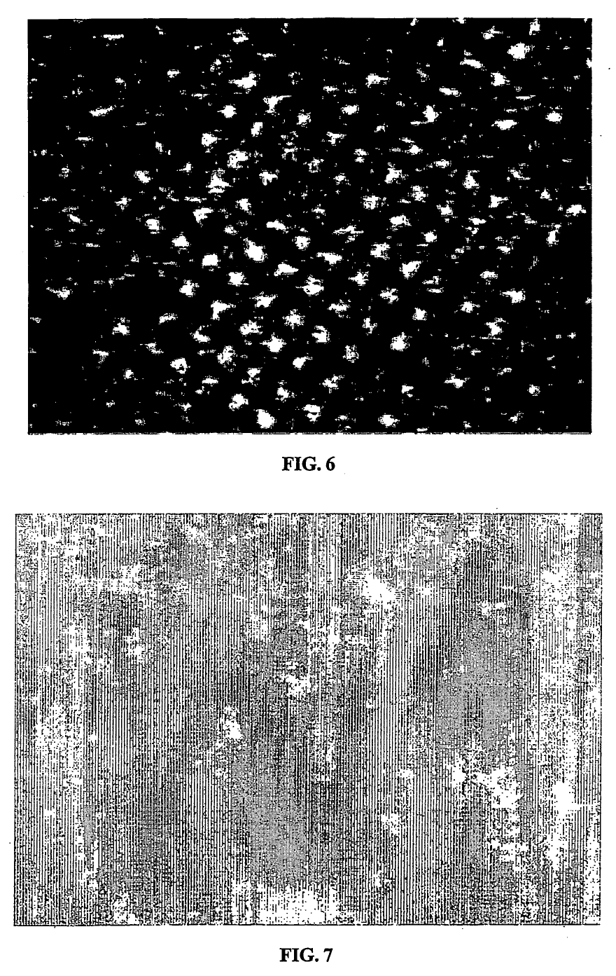

FIG. 6 shows a photograph of the top of the microporous membrane of the valve according to the invention when the polymer is in the retracted state, that is to say when the valve is in the open state; and

FIG. 7 shows a photograph of the top of the microporous membrane of the valve according to the invention when the valve is again in the closed state.

To produce the valve according to the invention, a device as shown in FIG. 1 is used. This device 10 is made up of a flat support 12 made of a polymer material. Such a material may, for example be polytetrafluoroethylene (PTFE) or any material having equivalent properties. This support has a thickness of about 3 millimeters. It has a through-hole 14 produced by drilling. This hole has a preferably circular cross section. However, the cross section could have any other outline. The diameter of the through-hole is 3 mm. However, it may be between 20 μm and 5 mm. A microporous membrane 16 is fastened to the support on its lower face, so that it covers the lower end of the through-hole 14. This fastening is performed by means of deposits 17 and 18 of an adhesive material, such as a Rhodorsil® CAF4 silicone resin from Rhodia. Other equivalent materials may be used to fasten the microporous membrane 16 to the support 12.

In a first embodiment, the microporous membrane 16 is formed by a conductive metal mesh. Thus, this mesh may be made of gold and is composed of wires with an approximately circular cross section of diameter approximately equal to 5 microns (μm). The distance between the mesh cells is advantageously 11 μm. The top of this mesh is shown by the photograph in FIG. 2.

According to this first entirely nonlimiting embodiment of the invention, the mesh 16 has an electrical connection, formed by a conducting wire 20 connected electrically to said mesh by means of a deposit 22 of silver lacquer. According to this embodiment, the connection wire 20 passes through said support 12 via a second through-hole 24 provided in the support 12, but of smaller cross section. As may be seen in FIG. 1, the deposit of resin 18 also has the purpose of insulating the electrical connection formed by the deposit 22 of the silver lacquer. Thanks to this electrical connection, the mesh 16 acts as an electrode.

A second conducting wire 26 is placed on the upper face of the support 12 and is connected to a platinum counterelectrode 28 placed vertically above the mesh 16 and preferably centered with respect to the mesh 16.

In an advantageous variant of the invention (not shown), the device may have two counterelectrodes. In this variant, the first counterelectrode is placed in the same way as in the embodiment described above. However, the second counterelectrode is preferably placed beneath the mesh 16, so as to be approximately symmetrical with respect to the first counterelectrode. Such a variant can be used to improve the deposition of monomer on the microporous membrane and therefore to obtain a polymerization of better quality.

To functionalize the microporous membrane by polymerization, the device is then immersed in an electrochemical cell (not shown). The electrode formed by the mesh 16 and the counterelectrode 28 are connected to a voltage generator. The electrochemical cell has a reference electrode. This reference electrode may, for example be of the Ag/AgCl type.

The cell contains an electrochemical solution comprising a monomer, which may be 3-methyl thiophene, pyrrole or any one of their derivatives, in a solvent, which may be acetonitrile or any equivalent solvent well known to those skilled in the art.

This electrochemical solution also contains an electrolytic salt, which may be lithium paranaphthalenesulfonate, lithium paratoluenesulfonate or LiCF₃SO₃, again diluted in the solvent. Very advantageously, the anion of the electrolytic salt has a high steric hindrance. This is because, during polymerization, the anion from the electrolytic salt is linked with the polymer so that the size and bulk of the polymer is greater the greater the steric hindrance of the anion.

An example of an electrolytic solution may, for example be an acetonitrile solution containing 5×10⁻¹ mol/l of 3-methyl thiophene and 2×10⁻¹ mol/l of LiCF₃SO₃. voltage is applied to the electrochemical cell—the applied potential may be constant. However, it is advantageous to carry out cyclic voltammetry. Thus, the applied potential may vary between a potential of −0.3 V/Ag/AgCl and a potential of 1.6 V/Ag/AgCl in the case of the electrolytic solution described above.

The entire device is placed under a stereoscopic microscope so as to monitor the change in polymerization.

As may be seen in FIG. 2, and as described above the gold mesh used in the device is initially a virgin mesh containing no polymer material.

Once the cell has been energized, the monomers contained in the electrolytic solution are deposited on the wires of the mesh constituting the electrode. A view at this stage of the functionalization is shown in FIG. 3.

Once the mesh has been covered with monomer, the polymer starts to grow in the pores of the mesh. This polymerization takes place radially, that is to say the polymer grows on the periphery of the pores in the form of filaments that converge on the center of the latter.

FIG. 4 shows the mesh at an intermediate stage in the polymerization. The filaments have partially blocked the pores. Only the central region of the pores is still free.

The polymerization continues until the polymer filaments join up at the center of the pores. At this stage, the polymerization is interrupted by cutting off the voltage generator. The moment when the polymerization is stopped is crucial. This is because it must take place when the polymer has entirely blocked the pores of the mesh to a sufficiently great extent for this polymer layer to have a certain impermeability. However, it must be stopped before the polymer filaments overlap one another, or even intermesh—this could jeopardize proper operation of the valve and in particular its opening.

Moreover, it is essential that all the pores of the microporous membrane be of the same size so as to ensure that the polymerization advances at the same rate, whatever the pore.

FIG. 5 shows the mesh once polymerization has stopped. It can be seen that the pores are completely blocked.

A means for suspending the polymerization at the opportune moment consists in predetermining the electric charge needed to carry out the polymerization at a given current intensity. Once this electric charge has been delivered the voltage generator is turned off.

In a second embodiment of the valve according to the invention, the microporous membrane 16 is not a conductive metal mesh but a nonconductive microporous membrane, for example made of a polymer material. Such a membrane may thus be made of polycarbonate of the NUCLEPORE (registered trademark) type manufactured by Whatman® or ISOPORE (registered trademark) manufactured by Millipore®. The use of such membranes is particularly suitable for producing the valve according to the invention insofar as the pore size is constant from one pore to another.

Preferably, the microporous membranes used have pores varying in size between 0.1 and 5 μm.

To cover the membrane with an electroactive polymer, it is necessary to make the membrane conductive. Preferably, the microporous membrane is rendered conductive by a metalization process.

This process consists firstly in placing the microporous membrane in a solution of anhydrous acetonitrile containing pre-purified pyrrole with a concentration of around 5×10⁻³ mol/l. This operation results in the adsorption of pyrrole monomer as a very thin film over the entire surface of the membrane (including the internal surface of the pores).

After being washed in an acetonitrile solution, the membrane is immersed in a solution of anhydrous acetonitrile containing, on the one hand, a salt, such as naphthalenesulfonate or lithium benzenesulfonate, with a concentration of 5×10⁻² mol/l and, on the other hand, ferric chloride FeCl₃ with a concentration of around 5×10⁻⁴ mol/l. This operation results in the layer of pyrrole being chemically polymerized to a film of conductive polypyrrole.

This membrane is electrically contacted by:
depositing a thin layer of a colloidal silver solution in one corner (with an area of 1 cm²) of the membrane; and
drying the silver layer, with which a contact is made (by a crocodile clip or the like, used in electrochemistry).

The membrane is then immersed in an electrolytic solution (such as one containing 2 g/l gold cyanide, 16 g/l potassium cyanide and 4 g/l disodium hydrogen phosphate) suitable for electroplating a gold film.

Cathode plating with a gold film, the thickness of which is controlled by the applied columbic charge, is then carried out. Preferably, this plating has a thickness of 40 or 50 nm.

The membrane thus obtained is then used in a similar device to that described in FIG. 1 and functionalized by the same method.

The operation of the microporous membrane as a valve is based on changing the oxidation-reduction state of the electroactive polymer covering the pores of the membrane. This is because when the valve is closed, that is to say when the polymer covers the pores of the membrane, as shown in FIG. 5, the polymer is in the oxidized state. In this state, the anion of the electrolytic salt is inserted into the polymer, resulting in an increase in the diameter of the polymeric fibers.

The valve is opened by changing the oxidation-reduction state of the polymer, namely by changing it from the oxidized state to the reduced state.

To do this, the device is placed in an electrochemical cell in the presence of an electrolytic solution containing a solvent, such as acetonitrile, and an electrolyte salt used to functionalize the microporous membrane, but in the absence of monomers. This electrolyte salt is preferably identical to the one used in the method of functionalizing the valve by polymerization. However, as a variant, it is possible to use other electrolytic solutions such as a solution of NaCl in water. The electrolytic salt is contained in the solution with a concentration lying in the range from 10⁻¹ to 5×10⁻¹ mol/l.

To change the oxidation-reduction state of the polymer, a voltage is applied to the terminals of the electrochemical cell. This voltage varies on either side of the oxidation-reduction potential of the polymer used. Preferably, the voltage applied varies between −5 and +5 volts, depending on whether it is desired to oxidize or reduce the polymer.

In this case, since the polymer is in the oxidized or doped state, a negative voltage of around −5 volts is applied so as to reduce it.

When the polymer is in the reduced or neutral state, the anion of the electrolytic salt inserted into the polymer is expelled into the solvent, resulting in a decrease in the volume of the polymer fibers by a factor of 4, so that they are no longer sufficiently bulky to block off the pores of the microporous membrane, as may be seen in FIG. 6. It follows that the valve returns to the open position, permitting fluid to flow through the membrane via the pores.

Similarly, the valve may be closed by applying a positive voltage of around +5 volts in the electrochemical cell, so that once again the polymer is oxidized and consequently doped by the anion of the electrochemical cell. The valve therefore returns again to the closed state, as shown in FIG. 7.

To improve the opening/closing performance of the valve according to the invention, studies by the Applicant have shown that it could be advantageous, when functionalizing the valve by polymerization, to make the polymer pass in succession from the oxidized state to the reduced state so as to accustom the polymer to switch from the doped state to the undoped state. This process substantially improves the rate of doping and “dedoping” and consequently the speed with which the valve is closed and opened.

Thus, the valve according to the invention may preferably have an opening and closing time lying between 1 and 100 milliseconds, depending on the pore diameter of the microporous membrane, which advantageously varies between 0.2 and 1 μm.

The valve according to the invention may advantageously be integrated into a microfluidic device of the analysis card type. Such an analysis card is a combination, on one and the same support, a few square centimeters (cm²) in area, of a number of functions: management of the fluids (microfluidic function); chemical and/or biochemical reaction; separation of species present in the fluid; and detection of these species. This systems may fulfill, automatically and autonomously, all the functions of the entire conventional chemical and/or biochemical analysis chain while handling only very small amounts of reactants, of between a few nanoliters and a few microliters. The valve according to the invention may advantageously be positioned on the surface of the card or within a microchannel.

The valve according to the invention may be manufactured ex situ, using for example a continuous process. Thus, the microporous membrane may advantageously be packaged in the form of wide tapes stored as a reel. The method of functionalizing the microporous membrane by polymerization may therefore be carried out continuously, in a manufacturing line that includes an electrochemical cell containing the electrolytic solution and the monomer, the membrane tape being immersed, in sections, in the cell for the time needed to deposit the monomer on the membrane and to polymerize it. After drying, the membrane can then be repackaged in reel form ready for use. When it comes to be used, it is necessary to carry out a prior step of wetting it in a solvent.

If the membrane consists of a nonconductive material, the continuous functionalization process may advantageously be supplemented with the prior steps needed to metalize the membrane. Thus the manufacturing line may include, upstream a first electrochemical cell containing an electrolytic solution and the monomer, in which cell the attachment of the monomer on to the membrane takes place. The membrane is then immersed in a second cell containing the chemical polymerization agent (FeCl₃). The line includes a third cell with a metal solution, in which the membrane is immersed in sections in order to metalize it. The membrane thus metalized can then continue the polymerization functionalization process as described above.

One process for manufacturing the membrane as described above may, for example be equivalent to the one described in patent EP-B-0142089.

A membrane thus conditioned may therefore be used extemporaneously and integrated into a microfluidic device, as described above. To do this, the membrane tape obtained by the process described above may advantageously be cut up so as to be placed either on the surface of the microfluidic device or within a channel—consequently, the size and shape of the cut pieces are completely variable.

1. An electrically controlled fluidic valve separating two volume spaces, characterized in that it comprises:
at least one microporous membrane, the surface of which is at least partly covered with at least one electroactive polymer essentially placed within the pores of said microporous membrane, so that, when said polymer is in a defined oxidation-reduction state, it blocks off said pores; and
an electrical supply intended to allow said valve to switch from the closed state to the open state, and vice versa, by changing the oxidation-reduction state of the electroactive polymer.

2. The valve as claimed in claim 1, characterized in that the microporous membrane has approximately circular pores of approximately constant diameter.

3. The valve as claimed in claim 1, characterized in that the electrical supply has at least one electrode and at least one counterelectrode.

4. The valve as claimed in claim 3, characterized in that the electrode is formed by the microporous membrane.

5. The valve as claimed in claim 1, characterized in that the microporous membrane is made of a nonconductive material.

6. The valve as claimed in claim 5, characterized in that the nonconductive material is a polymer taken from the group comprising: polycarbonates (PC), polyamides (PA), polyethylene terephthalate (PET), polytetrafluoroethylene (PTFE) or Teflon®, and derivatives thereof.

7. The valve as claimed in claim 5, characterized in that the nonconductive material is a polymer taken from the group comprising: cellulose esters, cellulose nitrates and blends thereof.

8. The valve as claimed in claim 5, characterized in that the membrane further includes at least one external metal layer.

9. The valve as claimed in claim 8, characterized in that the membrane further includes at least one intermediate polymeric layer to which the external metal layer is fastened.

10. The valve as claimed claim 1, characterized in that the microporous membrane is made of a conductive material.

11. The valve as claimed in claim 10, characterized in that the conductive material is a metal taken from the group comprising: gold, platinum, palladium or any other equivalent material.

12. The valve as claimed in claim 1, characterized in that the electroactive polymer is a conjugated polymer taken from the group comprising: polyaniline, polypyrrole, polythiophene, polyparaphenylvinylene, poly(p-pyridylvinylene) and derivatives thereof.

13. The valve as claimed in claim 2, characterized in that the pore diameter lies in the range from 0.1 to 5 microns (μm), preferably from 0.2 to 1 μm.

14. The valve as claimed in claim 1, characterized in that the microporous membrane has a thickness lying within the range from 10 μm to 1 mm, preferably from 10 to 30 μm.

15. A microfluidic device, characterized in that it includes at least one valve as claimed in claim 1.

16. A process for producing a valve as claimed in claim 1, characterized in that it comprises the following steps:
a) a microporous membrane is placed in an electrolytic solution containing at least one monomer;
b) an electrochemical current is induced in said electrolytic solution;
c) the monomer is fixed on to the microporous membrane, and especially in the pores of said membrane;
d) the radial polymerization of the monomer in the pores of said membrane is carried out; and
e) the polymerization is stopped by cutting off the electrochemical current when the polymers reach the center of the pores, so that said polymers block the pores without overlapping one another.

17. The process as claimed in claim 16, characterized in that it includes a prior step of metalizing the microporous membrane when said membrane is made of a nonconductive material, said metalization step comprising the following substeps:
a′) a microporous membrane is placed in a monomer solution;
b′) the monomer is fixed onto the microporous membrane;
c′) the polymerization of the monomer is carried out over the entire surface of the membrane so as to obtain a polymer layer;
d′) the membrane thus obtained is placed in a solution containing at least one metal salt; and
e′) the electrodeposition of the metal on the polymer layer is carried out by an oxidation-reduction reaction so that the microporous membrane is covered with a metal film.

18. The process as claimed in claim 1, characterized in that the monomer is taken from the group comprising: pyrrole, thiophene and derivatives thereof.

19. The process as claimed in claim 17, characterized in that the metal salt is taken from the group comprising: gold cyanide, gold chloride or any equivalent compound.
